(19) United States
(12) Patent Application Publication
(10) Pub. No.: US 2004/0027659 A1
(43) Pub. Date: Feb. 12, 2004

(54) Sample holder

(76) Inventors: Robert G. Messerschmidt, Corrales, NM (US); Howland D. T. Jones, Edgewood, NM (US); Robert D. Johnson, Albuquerque, NM (US); V. Gerald Grafe, Corrales, NM (US)

Correspondence Address: V. Gerald Grafe, esq., General Counsel, InLight Solutions, Inc., 800 Bradbury SE, Albuquerque, NM, 87106, US

(21) Appl. No.: 10/628,839

(22) Filed: Jul. 28, 2003

Related U.S. Application Data
(60) Provisional application No. 60/401,976, filed on Aug. 8, 2002.

(51) Int. Cl. G02B 23/00

(52) U.S. Cl. 359/425

(57) ABSTRACT

A sample holder comprising a material that is functionally transparent to wavelengths of light that are important to visual analysis of the sample, and to wavelengths of light that are important to spectroscopic analysis of the sample. Embodiments of the invention are amenable to total internal reflection of light useful in spectroscopic analysis. Specific materials and configurations are described. Methods and apparatuses using such sample holders for measurement of sample properties, including cancer screening of cervical samples, are described.

### CROSS REFERENCES TO CO-PENDING APPLICATIONS

This application claims priority under 35 U.S.C § 119 to U.S. provisional application 60/401,976, “Interrogation of a Sample,” filed Aug. 8, 2002, incorporated herein by reference.

### FIELD OF THE INVENTION

The present invention generally relates to sample holders, such as slides, useful in determining properties of samples.

### BACKGROUND OF THE INVENTION

Samples, such as samples of biological materials, are often placed on a holder in preparation for measurement and analysis. A contemporary microscope slide is a common example of such a sample holder. In some applications, a thin slice of a biological sample or a smear of biological cells is placed on such a slide. In other applications, a sample is plated onto a slide using a liquid-based methodology. See, e.g., “The Continual Evolution of the Pap Smear”. OB/GYN special edition, vol. 5. 2002. Once the sample is appropriately prepared, the sample can be examined by placing the holder in relationship to a microscope. A wide variety of sample preparation methods, staining materials and techniques, and optical microscope instruments are in use, allowing human visual analysis of samples.

Some sample characteristics can be determined using the response of a sample to incident radiation. For example, some substances absorb certain wavelengths of light more than they absorb other wavelengths of light. These absorptions are due to the rotational and vibrational energy levels of bonds, functional groups and molecules. The resulting spectra can contain information about the biochemical make-up of the samples. The presence or absence of a substance can be detected by analyzing the absorption characteristics of a sample. Also, the presence and relative concentrations of multiple substances can be determined by analyzing the absorption characteristics of a sample, as well as the ability to classify between types of samples. See, e.g., Skoog, D. A. and J. J. Leaiy, Principles of Instrumental Analysis, Fort Worth: Saunders, 1992; J. Fahrenfort, Spectrochim. Acta 17, 698 (1961); Harrick, N.J., Internal Reflection Spectroscopy, New York: Wiley Interscience, 1967; Fringeli UP, Goette J, Reiter G, Siam M, and Baurecht D (1998) Structural Investigations of Oriented Membrane Assemblies by FTIR-ATR Spectroscopy, In Proceedings of the 11th International Conference on Fourier Transform Spectroscopy; James A. de Haseth, Ed., AIP Conference Proceedings no. 430, 1998, The American Institute of Physics, Woodbury, N.Y.

Some sample analysis methods use radiation with wavelengths outside the visible spectrum, such as infrared or ultraviolet. The sample-holding methods used with such wavelengths are generally different from those used with human visual analysis of samples, due to differing optical requirements, and differing system design characteristics.

Combinations of spectroscopic analysis and human visual analysis have been proposed, as have spectroscopic methods used to replace, pre-screen, or augment human visual analysis. See, e.g., “Spectral Imaging and Microscopy”, Levenson and Hoyt, American Laboratory, 2000.; Jones, U.S. patent application Ser. No. 10/262,292, “Within-sample Variance Classification of Samples,” incorporated herein by reference; Haaland, U.S. Pat. No. 5,596,992, “Multivariate Classification of Infrared Spectra of Cell and Tissue Samples”, incorporated herein by reference. Contemporary approaches require a specialized sample holding method, compatible with the spectroscopic measurements. Combination with human analysis requires another sample holding method, compatible with the human visual analysis (e.g., a microscope slide). As an example, screening for human cervical cancer is conventionally accomplished by human visual analysis of a microscope image of cervical cells plated onto a conventional microscope slide. Spectroscopic systems for such screening can require spectroscopic measurements in the infrared region, and currently require special sample treatments, incompatible with conventional optical microscopy. This incompatibility can lead to disparate results, as when, for example, the characteristic being screened is present in the sample portion used in one method but not the other. It can also lead to calibration and reference difficulties since the spectroscopic measurement and the human optical analysis are not examining the same sample portion and holder. A sample holder amenable to both human visual an alysis and spectroscopic measurement would reduce these detrimental effects.

### SUMMARY OF THE INVENTION

The present invention provides a sample holder that allows human visual analysis and spectroscopic analysis to be performed on the same sample. A sample holder according to the present invention can comprise a body having first and second surfaces, substantially parallel to each other, separated by a material that is functionally transparent to wavelengths of light that are important to human visual analysis and to wavelengths of light that are important to spectroscopic analysis. Some embodiments of the present invention are functionally transparent to near-infrared light; some are functionally transparent to mid-infrared light. Some embodiments have body dimensions compatible with conventional optical microscopes. Some embodiments comprise a body material whose index of refraction is amenable to total internal reflection within the body. The present invention contemplates various suitable materials, and various relationships among the surfaces of the body to accommodate total internal reflection as part of the spectroscopic analysis.

The present invention also can comprise a sample holder having a sample interface mounted with a frame. In these embodiments, the sample interface can comprise first and second substantially parallel surfaces, separated by a material that is functionally transparent to wavelengths of light that are important to human visual analysis and to wavelengths of light that are important to spectroscopic analysis. Some embodiments of the present invention are functionally transparent to near-infrared light; some are functionally transparent to mid-infrared light. Some embodiments comprise a sample interface material whose index of refraction is amenable to total internal reflection within the body. The present invention contemplates various suitable materials, and various relationships among the surfaces of the sample interface to accommodate total internal reflection as part of the spectroscopic analysis. The frame can have dimensions that are compatible with conventional instruments, for example conventional optical microscopes, infrared microscopes, and focal plane array instruments.

The present invention also comprises sample holders suited for visual and spectroscopic analysis of cervical samples, and methods of using such a sample holder in the analysis of cervical samples.

### BRIEF DESCRIPTION OF THE DRAWINGS

FIG. 1 is a schematic representation of a sample holder in accordance with the present invention;

FIG. 2 is a schematic representation of attenuated total internal reflection in a sample holder in accordance with the present invention;

FIG. 3 is a schematic representation of a sectional view of a sample holder in accordance with the present invention;

FIG. 4 is a schematic representation of a sectional view of a sample holder in accordance with the present invention;

FIG. 5 is a schematic representation of a sectional view of a sample holder in accordance with the present invention;

FIG. 6 is a schematic representation of a sectional view of a sample holder in accordance with the present invention;

FIG. 7 is a schematic representation of a sectional view of part of a sample holder in accordance with the present invention;

FIG. 8 is a schematic representation of a sectional view of part of a sample holder in accordance with the present invention;

FIG. 9 is a schematic representation of a sample holder in accordance with the present invention;

FIG. 10 is a schematic representation of a sample holder in accordance with the present invention;

FIGS. 11(a,b,c,d,e) comprise schematic representations of sectional views of various sample holders in accordance with the present invention.

FIG. 12 is a schematic representation of an example apparatus suitable for some applications of the present invention.

FIG. 13 is an illustration of an example application: a spectrum of dried cervical cells using a sample holder according to the present invention.

FIG. 14 is an illustration of an example application: a spectrum of dried serum using a sample holder according to the present invention.

FIG. 15 is an illustration of an example application: spectral measurements of non-biological materials using a sample holder according to the present invention.

FIG. 16 is a plot of optical characteristics of a material suitable for use in some embodiments of the present invention.

### DETAILED DESCRIPTION OF THE INVENTION

The drawings, which are not necessarily to scale, depict illustrative embodiments and are not intended to limit the scope of the invention.

For the purposes of the application, the term “about” applies to all numeric values, whether or not explicitly indicated. The term “about” generally refers to a range of numbers that one of skill in the art would consider equivalent to the recited value (i.e., having the same function or result). In some instances, the term “about” can include numbers that are rounded to the nearest significant figure. For the purposes of this application, the term “light” refers to electromagnetic radiation of any wavelength. “Infrared light” refers to electromagnetic energy with wavelength from about 0.7 to about 25 microns. “Near-infrared light” refers to electromagnetic radiation with wavelength from about 0.7 to 2.5 microns. “Mid-infrared light” refers to electromagnetic radiation with wavelength from about 2.5 to 25 microns. “Visible light” refers to electromagnetic radiation with wavelength from about 0.4 to about 0.7 microns.

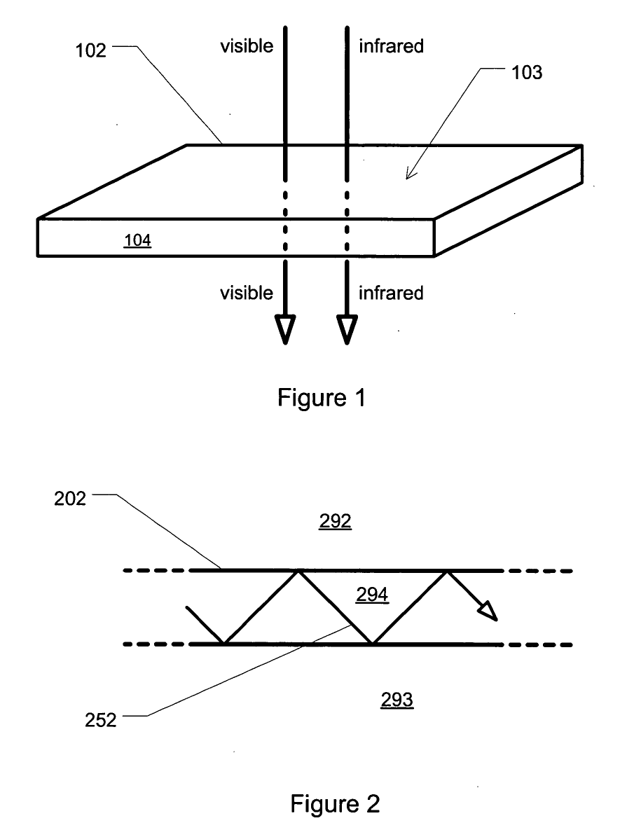

The present invention provides a sample holder that allows both human visual analysis and spectroscopic analysis of the same sample, using the same sample holder. FIG. 1 is a schematic illustration of a sample holder according to the present invention. The sample holder 102 comprises a surface 103 that is amenable to holding appropriate samples. For many applications, the surface 103 comprises a generally planar surface. For some applications, the surface 103 can be coated with various materials that enhance the sample-holding characteristics of the surface 103. See, e.g., “The Continual Evolution of the Pap Smear”. OB/GYN special edition, vol. 5. 2002. The body 104 of the holder 102 comprises a material that is functionally transparent to both visible light and to infrared light. Specific visual analysis methods can require transmission of certain wavelengths; specific spectroscopic analysis methods can similarly require transmission of certain wavelengths.

“Functionally transparent” means that the material does not absorb, at wavelengths important to subsequent analysis, sufficient energy to impair that analysis. Materials that exhibit this type of behavior are often referred to as “optically clear”, or transparent. That is, they are capable of transmitting light with little absorption and no appreciable scattering or diffusion. One can determine if a material is functionally transparent for the current application by, for example, examining a plot of transmission versus wavelength, particularly in the visible, near-, and mid-infrared regions. FIG. 16 shows such a plot for a multispectral grade of ZnS sold under the trademark CLEARTRAN. This curve is a combination of surface and internal transmission of the material. Fresnel reflection (described below) losses at the surfaces account for about a 27% reduction in transmission; the remaining difference is due to internal absorption of the material. Of particular note is the flatness of the curve throughout the entire spectral region plotted. Even at about 11 microns wavelength, where the material exhibits a slight dip in transmission to about 50%, this material would perform well. This material would be deemed acceptable for the given application over the entire range from 0.4 to 13.0 microns, and would be considered functionally transparent for applications sensitive to those wavelengths.

In addition, materials plotted in this fashion that show very little transmission (i.e., less than 10%) in certain wavelength regions can be acceptable provided those wavelength regions are not useful in making a determination about the characteristics of interest of a sample. For example, a material that exhibits high transmission in the visible and mid-infrared regions, but low transmission in the near-infrared region can be acceptable, and be considered functionally transparent, for use in applications requiring analysis in the visible and mid-infrared regions. In general, materials with internal transmission of from about 10% to 100% at wavelengths of interest, and with low to no scattering, can be suitable for use as a sample holder in the present application.

In an example application such as analysis of Pap samples, visual analysis can require transmission of at least some wavelengths of visible light, and spectroscopic analysis can require transmission of at least some wavelengths of mid-infrared light. Conventional sample holders are intended for either visual or spectroscopic measurements. In contrast, a sample holder according to the present invention can comprise a material made from clear or multi-spectral grade of zinc sulfide (ZnS), which can be used for both visual and spectroscopic measurements. Such materials are currently marketed under the trade names CLEARTRAN by Rohm and Haas Inc., and MultiSpectral grade ZnS by II-VI Inc. These materials are water-clear forms of chemically vapor deposited (CVD) zinc sulfide that have been modified by a hot isostatic pressing (HIP) process. Other materials that are functionally transparent in both visible and infrared portions of the electromagnetic spectrum, such as Barium Fluoride, Caesium Iodide, Calcium Fluoride, Cubic Zirconium, Diamond, Irtran-2, Lithium Fluoride, Magnesium Fluoride, Potassium Bromide, Potassium Chloride, Quartz, Sapphire, Silver Bromide, Silver Chloride, Sodium Chloride, Thallium Bromide, Thallium Bromo-lodide, Thallium Bromo-Chloride, Zinc Selenide, and Zinc Sulfide can also be suitable. The preceding is not to be considered a comprehensive list; other materials can be suitable.

The present invention also provides a sample holder that facilitates spectroscopic analysis by attenuated total internal reflection. FIG. 2 is a schematic representation of attenuated total internal reflection in a sample holder in accordance with the present invention. Attenuated Total Reflectance (ATR) is a popular technique in infrared spectroscopy. The spectroscopic usefulness of the effect was first noticed in the 1960's by Fahrenfort and is predictable from basic optical physics. Basically, when light 252 propagates through a medium of high refractive index 294 and approaches an interface 202 with a material of lower refractive index 292, a transmission and a reflection will occur. The relative strengths of these transmissions and reflections are governed by the Fresnel equations:

$${r}_{⊥} ≡ \frac{{E}_{r}}{{E}_{i}} = \frac{\frac{{n}_{1}}{{μ}_{1}} cos θ - \frac{{n}_{2}}{{μ}_{2}} cos {θ}^{′}}{\frac{{n}_{1}}{{μ}_{1}} cos θ + \frac{{n}_{2}}{{μ}_{2}} cos {θ}^{′}}$$

$${t}_{⊥} ≡ \frac{{E}_{t}}{{E}_{i}} = \frac{2 \frac{{n}_{1}}{{μ}_{1}} cos θ}{\frac{{n}_{1}}{{μ}_{1}} cos θ + \frac{{n}_{2}}{{μ}_{2}} cos {θ}^{′}}$$

$${r}_{‖} ≡ \frac{{E}_{r}}{{E}_{i}} = \frac{\frac{{n}_{2}}{{μ}_{2}} cos θ - \frac{{n}_{1}}{{μ}_{1}} cos {θ}^{′}}{\frac{{n}_{1}}{{μ}_{1}} cos {θ}^{′} + \frac{{n}_{2}}{{μ}_{2}} cos θ}$$

$${t}_{‖} ≡ \frac{{E}_{t}}{{E}_{i}} = \frac{2 \frac{{n}_{1}}{{μ}_{1}} cos θ}{\frac{{n}_{1}}{{μ}_{1}} cos {θ}^{′} + \frac{{n}_{2}}{{μ}_{2}} cos θ}$$

where, for example, n₁ is the refractive index of the sample holder 294 and n₂ is the refractive index of the medium 292 outside the sample holder, and n₁>n₂.

The Fresnel equations give the ratio of the reflected and transmitted electric field amplitude to initial electric field for electromagnetic radiation incident on a dielectric. In general, when a wave reaches a boundary between two different dielectric constants, part of the wave is reflected and part is transmitted, with the sum of the energies in these two waves equal to that of the original wave.

Examination of these equations reveals that when the light is traversing through a high index medium and approaching an interface with a low index medium, for a range of angles the reflected component is total, and no light is transmitted. The minimum angle, measured from the surface normal, at which this occurs is called the critical angle and is defined by the following equation:

$${θ}_{c} = {sin}^{- 1} ( \frac{{n}_{2}}{{n}_{1}} )$$

The reflected component has an angle of reflection equal and opposite to the angle of incidence upon the interface. Above the critical angle, all light is reflected. Below the critical angle, some light would transmit through the interface according to the above Fresnel equations, refracted according to Snell's Law:

n₁ sin θ=n₂ sin \acute{θ}

As stated, above the critical angle reflection is total. Fahrenfort first noticed that upon total reflection, a standing, or evanescent, wave is set up at the interface. See, e.g., Fahrenfort. The wave has an exponentially decaying intensity into the rarer (lower index) medium. If an absorbing substance, or sample, is placed in the vicinity of this evanescent wave, which extends a few wavelengths in to the rarer medium, it can absorb portions of the light at specific wavelengths corresponding to the absorption properties of the sample. It follows that this mode can be used to obtain an infrared spectrum of a sample in contact with the high index medium through which the light is traveling.

We can predict the strength of this interaction through several equations developed by Harrick. First, the depth of penetration:

$${d}_{p} = \frac{\frac{λ}{{n}_{1}}}{2 {π ( {sin}^{2} θ - {( \frac{{n}_{2}}{{n}_{1}} )}^{2} )}^{\frac{1}{2}}}$$

where n₂ is the refractive index of the sample and n₁ is the refractive index of the sample holder. The depth of penetration is defined as the point at which the strength of the evanescent wave electric vector decays to a value of 1/e from its original strength. Approximate calculations are often done using the depth of penetration to characterize the strength of signal that will be obtained with ATR. A more accurate equation was derived by. Harrick, namely the effective thickness, dₑ. See, e.g., Harrick. An additional complication arises if the sample is thin compared to the 1/e point of the evanescent wave, a situation presented by some applications of the present invention. The thickness of a thin layer of cells can be thin relative to the depth of penetration. The effective thickness calculation results in a number that can be used in Beer's Law calculations, and is closely related to the pathlength in a transmission measurement made at normal incidence. See, e.g., Skoog. There are now three refractive indices of interest: n₁, the index of the crystal, n₂, the index of the thin sample, and n₃, the index of whatever is beyond the sample, usually air. Also, since the geometry is usually not near-normal, the calculation must be done for three orthogonal axes. Finally, the measurement can be polarization dependent and should be calculated for two orthogonal polarizations. For purposes of this discussion, the thin layer is assumed to by isotropic and the polarization is deemed to be random.

So the effective depth equation, for thin films where the film thickness is much less than the depth of penetration, is as follows:

$${d}_{e} = \frac{1}{cos θ} \frac{{n}_{2}}{{n}_{1}} \frac{{d}_{p}}{2} {E}_{02}^{r2} \cdot ( exp ( - \frac{2 {z}_{i}}{{d}_{p}} ) - exp ( \frac{2 {z}_{f}}{{d}_{p}} ) )$$

where the z values are the initial and final z-dimension positions of the film relative to the surface of the ATR prism.

The E term is the square of the strength of the electric vector in medium 2 (the film). E is proportional to light intensity. For polarized incident light:

$${E}_{02 , ‖}^{r2} = {E}_{02 , x}^{r2} + {E}_{02 , z}^{r2}$$

$$and$$

$${E}_{02 , ⊥}^{r2} = {E}_{02 , y}^{r2}$$

$$and this results in \text{:}$$

$${d}_{e , ‖} = {d}_{ex} + {d}_{ez}$$

$$and$$

$${d}_{e , ⊥} = {d}_{ey}$$

$$and finally$$

$${d}_{e , random} = ( {d}_{e ⊥} + {d}_{e , ‖} ) / 2$$

The three orthogonal electric field components are calculated by means of Fresnel's equations:

$${E}_{0 x , 2}^{r} = \frac{2 cos {θ ( {sin}^{2} θ - {n}_{31}^{2} )}^{\frac{1}{2}}}{{{( 1 - {n}_{31}^{2} )}^{\frac{1}{2}} [ ( 1 + {n}_{31}^{2} ) {sin}^{2} θ - {n}_{31}^{2} ]}^{\frac{1}{2}}}$$

$${E}_{0 x , 2}^{r} = \frac{2 cos θ sin θ {n}_{32}^{2}}{{{( 1 - {n}_{31}^{2} )}^{\frac{1}{2}} [ ( 1 + {n}_{31}^{2} ) {sin}^{2} θ - {n}_{31}^{2} ]}^{\frac{1}{2}} \\}$$

$$and$$

$${E}_{0 y , 2}^{r} = \frac{2 cos θ}{{( 1 - {n}_{31}^{2} )}^{\frac{1}{2}}}$$

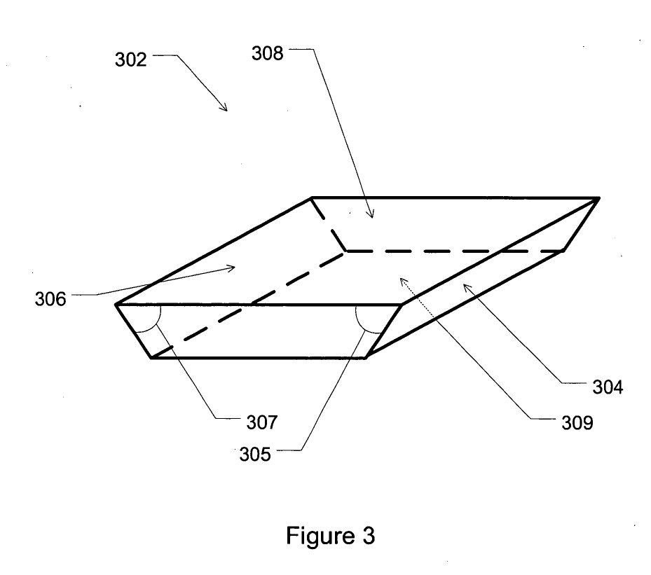

FIG. 3 is a schematic representation of a sample holder according to the present invention. The holder 302 comprises a body made of a material such as those discussed above. The holder 302 has surface 308 adapted to hold a sample of interest. Two opposing edges 304, 306 are oriented at angles 305, 307 respectively to the surface 308. Surfaces and edges can be polished to minimize scattering of light incident at those interfaces. In some embodiments, edges 304, 306 can be treated with antireflection coatings, reflection coatings, selective spectral transmission coatings (e.g., low pass, high pass, bandpass coatings), or combinations thereof, depending on the specific operating characteristics required (e.g., optical throughput, wavelength filtering, etc.). Additionally, surfaces 308 and 309 can be substantially parallel to each other in order to achieve and maintain total internal reflection of the light within the holder. Angles 305, 307 can be chosen to be similar or different. Typical ranges of angles 305, 307 can be from 10 to 170 degrees as measured from surface 308 as shown. Values for angles 305, 307 are chosen such that light incident on, and passing through, edge 304 or edge 306 will be totally internally reflected within the volume of the holder. Values for angles 305, 307 can be chosen as to allow light to exit through edges 304 or 306. Many factors can be considered in determining optimal values for angles 305, 307, such as beam divergence, wavelength, sample holder material, desired number of bounces within the sample holder, and incorporation of sample holder into instrumentation that may be used to determine characteristics of a sample. As an example, consider a sample holder of the present invention made of multispectral ZnS, which has a refractive index of 2.24661 at 5.0 microns wavelength, surrounded by air. The critical angle is accordingly 24.6 degrees. Angles 305, 307 can therefore be chosen to be 50 degrees such that collimated light incident normal to, and passing through, edge 304 will strike surface 308 at 50 degrees. As this incident angle is above the critical angle, the light will be totally internally reflected within the sample holder.

Several methods can be employed in the fabrication of a sampler holder of the present invention. The particular method used can depend on the material chosen. For example, grinding and polishing techniques common to the manufacture of optical components are amenable to the fabrication of a sample holder made of multispectral ZnS. In this sense, surfaces 308 and 309 can be ground and polished flat and parallel to each other; then the edges 304, 306 can be ground and polished at the desired angle 305, 307 so as to allow for total internal reflection within the sample holder. To test whether total internal reflection is achieved, a collimated beam of light of a known wavelength (i.e., a laser) can be directed normally incident upon an edge, 304 or 306, of the sample holder in air, and the path of the beam observed. If the sample holder is designed and fabricated correctly, no light should escape through surfaces 308, 309.

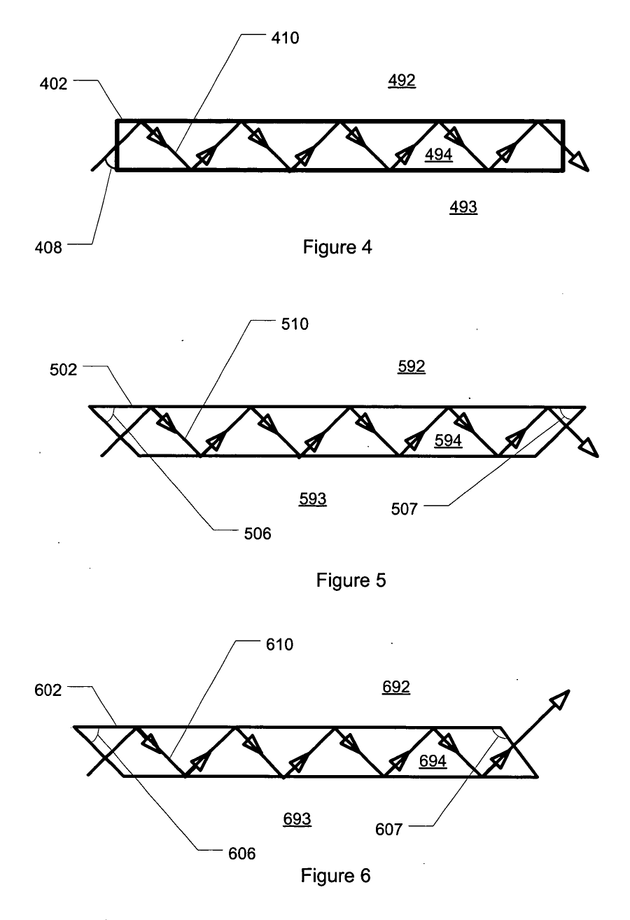

FIGS. 4, 5, 6, 7, and 8 are schematic representations of sectional views of various sample holders according to the present invention, illustrating various edge/surface relationships. The specific relationships shown are examples only; they can be combined and modified in various ways based on the understanding provided by the description. In FIG. 4, two opposing edges of a sample holder 402 are oriented approximately perpendicularly to the sample-holding surface. Light can be directed to the holder at an incidence angle such that total internal reflection is achieved within the holder, with conditions as described above. For some applications of the present invention, the refractive index of the sample holder can range from about 1.39 to 4.0. As an example, multispectral ZnS has a refractive index of 2.24661 at 5.0 microns wavelength. Therefore, in this embodiment where the refractive index of the holder 494 is greater than that of the surrounding media 492 and 493 (e.g., air), light directed at the holder at an incident angle 408 from 0 up to 90 degrees will pass through the edge and into the holder 494 and consequently undergo total internal reflection within the holder.

In FIG. 5, two opposing edges of a sample holder 502 are oriented at angles 506, 507 to the sample-holding surface. Angles 506, 507 are chosen such that the light passing through the edge and into the holder is incident on the sample holding-surface from within the holder at an angle equal to or greater than the critical angle. Light can be directed to the holder at any incidence angle such that total internal reflection is achieved within the holder. Typically one would desire to direct light at an angle of 0 degrees, or normal, to the edge of the holder. A cone of light can also be directed at this surface. Angles 506, 507 are also chosen so as to allow the light totally internally reflected within the holder to exit the holder through the opposing edge.

In FIG. 6, two opposing edges of a sample holder 602 are oriented at angles 606, 607 to the sample-holding surface. Angles 606, 607 are chosen such that the light passing through the edge and into the holder is incident on the sample holding-surface from within the holder at an angle equal to or greater than the critical angle. Light can be directed to the holder at an incidence angle such that total internal reflection is achieved within the holder. Typically one would desire to direct light at an angle of 0 degrees, or normal, to the edge of the holder. A cone of light can also be directed at this surface. Angles 606, 607 are also chosen so as to allow the light totally internally reflected within the holder to exit the holder through the opposing edge.

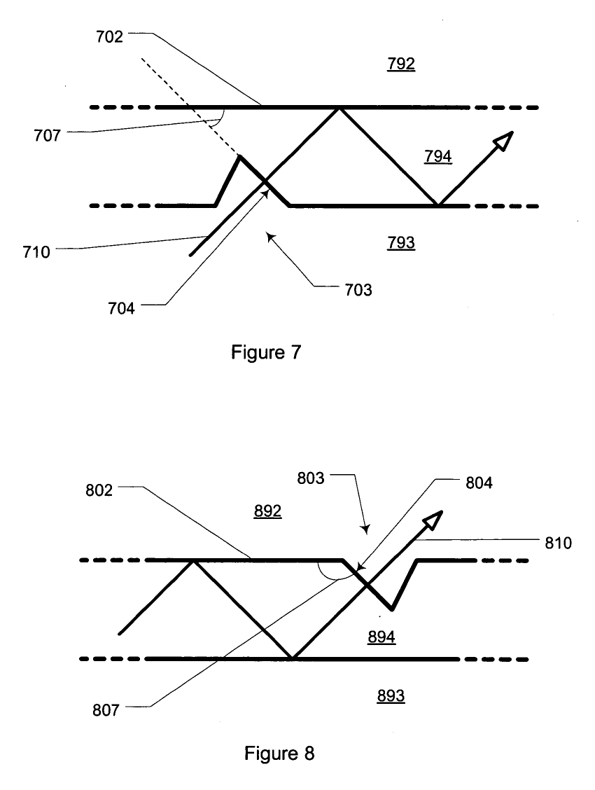

FIG. 7 is a schematic illustration of a sectional view of a part of a sample holder according to the present invention. The sample holder 702 comprises a body of a material 794 whose refractive index relates to the indices of the surrounding materials 792, 793 as discussed previously. The body defines a notch 703, where the notch 703 defines a first surface 704 that is oriented at an angle 707 to a surface of the sample holder 702. Angle 707 is chosen such that the light passing through the notch and into the holder is incident on the sample holding-surface from within the holder at an angle equal to or greater than the critical angle. The dimensions of the notch are chosen to allow for the substantially unobstructed passing of light into the sample holder, and can be dependent on several parameters such as beam divergence, wavelength, sample holder material, desired number of bounces within the sample holder, and incorporation of sample holder into instrumentation that can be used to determine characteristics of a sample.

FIG. 8 is a schematic illustration of a sectional view of a part of a sample holder according to the present invention. The sample holder 802, like that in FIG. 7, comprises a body of a material 894 whose refractive index relates to the indices of surrounding materials 892, 893 as discussed previously. The body defines a notch 803, with similar characteristics as discussed in FIG. 7. Light traveling an ATR path within the body can impinge on a surface 804 of the notch and exit from the body. The surface 804 can be oriented at an angle relative to the surface of the sample holder 802 such that light incident on surface 804 is at an angle less than the critical angle so as to allow the light to pass through the surface 804 and not be totally internally reflected back into the holder.

The incident and exiting light can pass through the same surface. An opposing edge can be coated with a reflective material so as to act as a mirror and return the light back on itself, allowing it to exit the sample holder from the same edge as it entered. Techniques for some suitable edge treatments (in a different application area) are discussed in Berman, et al., U.S. Pat. No. 6,421,548, incorporated herein by reference. In another embodiment, light can be launched into both edges of the sample holder simultaneously and detected as it exits from either or both edges.

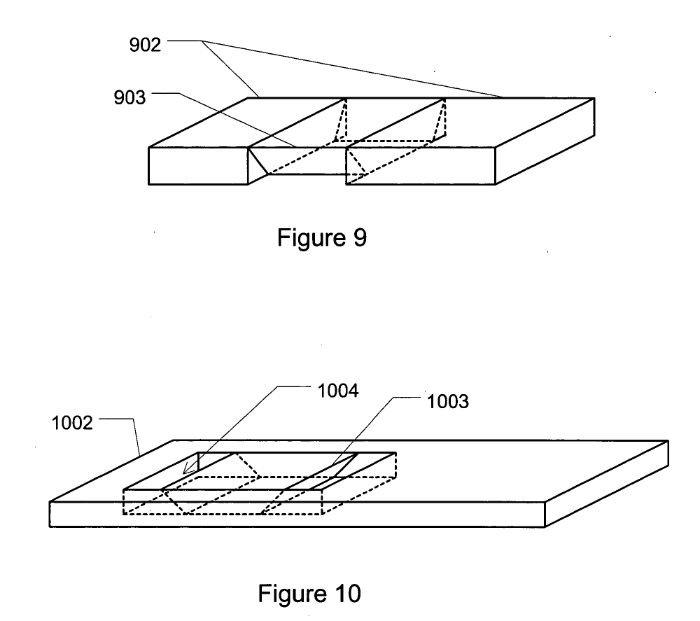

FIG. 9 is a schematic illustration of a sample holder according to the present invention. The sample holder comprises a frame 902. A sample interface 903 mounts with the frame. The frame 902 can be configured so that it is compatible with conventional optical microscopy standards. For example, the frame 902 can have a length, width, and thickness compatible with conventional microscope slides: nominally about 1″ wide×3″ long×0.04″ thick. Other dimensions are also available; in some applications the thickness can vary. The sample interface 903 can be similar to the sample holders discussed previously, except adapted to mount with the frame 902. As an example, the sample interface can be glued to the frame. As another example, the sample interface can be mechanically retained by the frame, e.g., by clips or compatible retaining slots. The sample to be measured can be deposited on the sample interface for spectroscopic analysis. The sample on the sample interface, and possibly additional sample deposited on the frame, can be measured optically. The frame can also be adapted to provide other functions: the frame can incorporate tracking and identification markers; the frame can incorporate features adapted to help register the device position; the frame can incorporate specific shapes, e.g., holes, protrusions, or channels, to interface with automated handling mechanisms.

FIG. 10 is a schematic illustration of a sample holder according to the present invention. A frame 1002 mounts with a sample interface 1003. The sample interface 1003 mounts with the frame 1002 such that light can be directed into the sample interface 1003; in the figure, a gap 1004 between the frame 1002 and the sample interface 1003 is shown. Other arrangements can also be suitable; some examples are discussed below. In the example of FIG. 10, the frame can be made to be compatible with conventional optical microscopy. The frame width can be about 1 inch wide, about 3 inches long, and about 0.04 inch thick, to accommodate analysis using conventional optical microscopy instruments. The sample interface 1003 can be made of materials such as those discussed previously, with light input and exit accommodations such as those discussed previously, to accommodate both optical analysis and spectroscopic analysis using ATR.

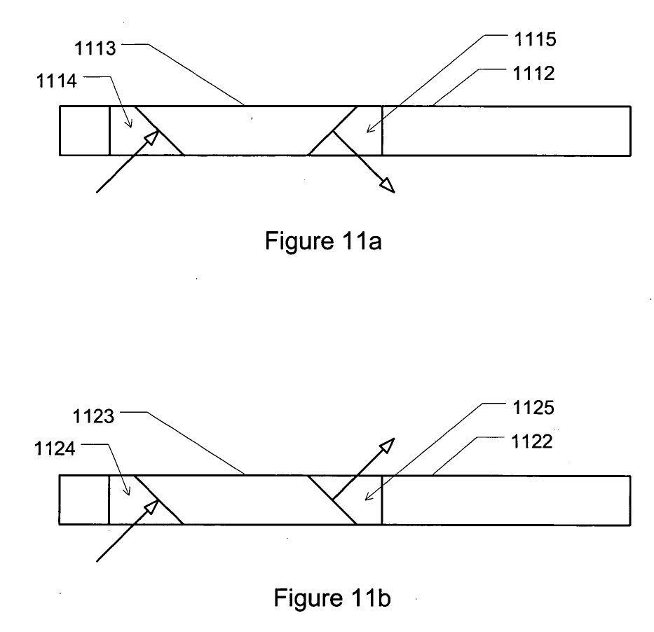

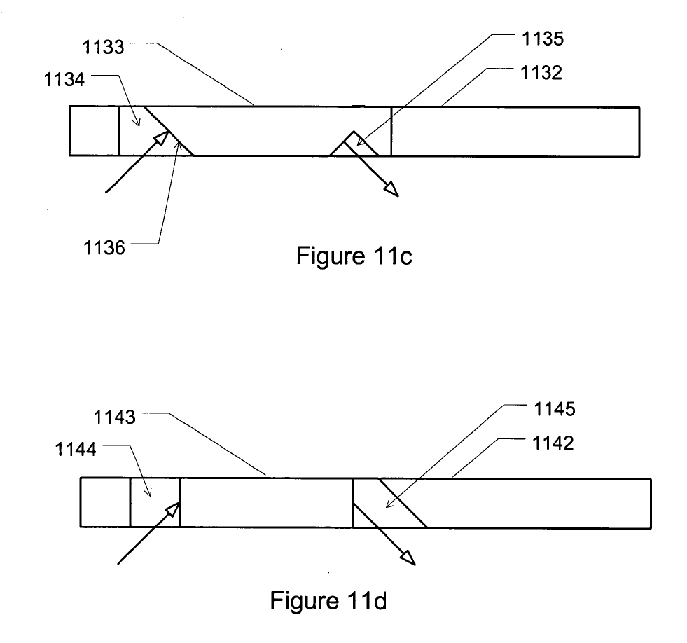

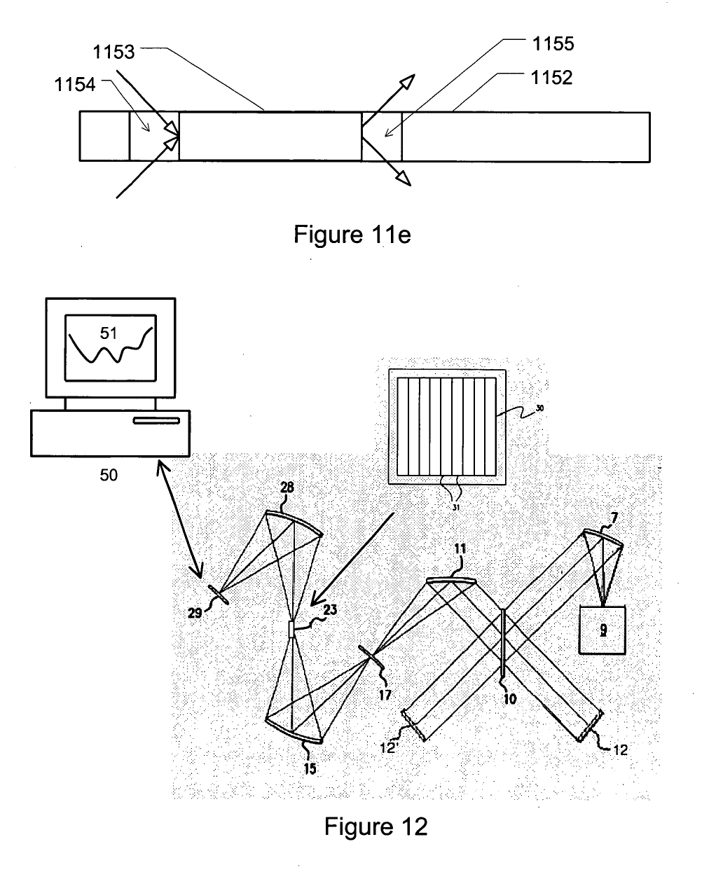

FIG. 11(a,b,c,d,e) comprise schematic illustrations of sectional views of several example embodiments of the present invention. In FIG. 11a, a carrier 1112 mounts with a sample interface 1113, in a similar manner as discussed for FIG. 10. The sample interface 1113 comprises a material such as those discussed previously. Two opposing edges of the sample interface 1113 are oriented at angles to a surface of the sample interface, accommodating ATR spectroscopic operation as discussed for FIG. 5. The mounting of sample interface 1113 and carrier 1112 provides for optical communication with the sample interface 1113 via gaps 1114, 1115. Gaps 1114, 1115 can be air. The size of the gaps 1114, 1115 can be chosen so as to allow for the substantially unobstructed passing of light into and out of the sample holder, and may be dependent on several parameters such as beam divergence, wavelength, sample holder material, desired number of bounces within the sample holder, and incorporation of sample holder into instrumentation that may be used to determine characteristics of a sample.

The present invention contemplates a variety of approaches for optically communicating with the sample holder. Air gaps such as those discussed above are an example. As another example, a space between the frame and the sample holder can be filled with a material amenable to light transmission: having refractive and transmissive properties suitable for optical communication with the sample holder in the wavelengths of interest to the intended application. As another example, the frame can include features such as waveguides, lightguides, or optical fibers that are aligned relative to the sample holder such that they afford optical communication therewith. As another example, an associated instrument can include features such as waveguides, lightguides, or optical fibers such that configuration of the sample holder and frame in the instrument encourages alignment of the waveguides, lightguides, or fibers with the sample holder. As another example, an associated instrument can include a compatible medium that is placed in optical contact with the sample holder in a manner that fosters internal reflection at the sample holder/sample surface. As an example of this, an interface component of a compatible material (e.g., of the same material as the sample holder, or of a material with similar optical properties as the sample holder) can be placed in optical contact with the sample holder. Light can be launched, collected, or both, from the interface component.

FIG. 11b is a schematic illustration of a sectional view of an example embodiment. As discussed for FIG. 11a, a sample interface 1123 mounts with a frame 1122. The sample interface in FIG. 11b comprises opposing edges oriented to receive and transmit light on opposite sides of the sample holder, similar to that discussed for FIG. 6. The mounting of sample interface 1123 and frame 1122 provides for optical communication with the sample interface 1123 via gaps 1124, 1115. Gaps 1124, 1125 can be as discussed for FIG. 11a.

FIG. 11c is a schematic illustration of a sectional view of an example embodiment. As discussed for FIG. 11a, a sample interface 1133 mounts with a frame 1132. The sample interface in FIG. 11c comprises a first edge 1136 oriented as discussed for FIG. 5. The mounting of sample interface 1133 and frame 1132 provides for optical communication with the first edge 1136 of the sample interface 1133 via gap 1134. Gap 1134 can be as discussed for FIG. 11a. The sample interface 1133 additionally defines a notch 1135, configured relative to the sample interface surface as discussed for FIG. 7 (a notch on the other surface, as in FIG. 8, would also be suitable). The use of a notch 1135 can obviate the requirement for a gap, which can simplify the mounting of sample interface 1133 to carrier 1132.

FIG. 11d is a schematic illustration of a sectional view of an example embodiment. As discussed for FIG. 11a, a sample interface 1143 mounts with a frame 1142. The sample interface in FIG. 11d comprises opposing edges oriented approximately perpendicularly to the sample-holding surface of the sample interface 1143, similar to that discussed for FIG. 4. The mounting of sample interface 1143 and frame 1142 provides for optical communication with the sample interface 1143 via gaps 1144, 1145. Gaps 1144, 1145 can be as discussed for FIG. 11a. One gap 1145 is shown with an inclined side, roughly parallel to the corresponding edge of the sample interface 1143. The inclined side may be used to benefit the coupling of light exiting the sample holder with the instrumentation used to determine characteristics of a sample.

FIG. 11e is a schematic illustration of a sectional view of an example embodiment. As discussed for FIG. 11a, a sample interface 1153 mounts with a frame 1152. The sample interface in FIG. 11e comprises opposing edges oriented approximately perpendicularly to the sample-holding surface of the sample interface 1153, similar to that discussed for FIG. 4. The mounting of sample interface 1153 and frame 1152 provides for optical communication with the sample interface 1153 via gaps 1154, 1155. Gaps 1154,1155 can be as discussed for FIG. 11a. This embodiment allows for the coupling of light into and out of the sample holder from both sides of the sample holder.

The example embodiments presented before do not explicitly show refraction of the light entering or exiting the surface of the sample holder. Refraction at the entrance or exit surfaces can affect the angular relationship of the light to the sample interface surface, in ways that are within the design skill of those skilled in the art. Some of the example embodiments can produce complete illumination of the sample holder surface, while some illuminate only a portion of the surface. The surface area illuminated can be determined from the design choices made concerning the angle and area of the light entry and exit surfaces, and the specifics of the incident/exiting light and the sample interface material itself. FIG. 11f is a schematic illustration of part of an example embodiment according to the present invention. A sample interface mounts with a frame 1162, similar to the relationship discussed in FIG. 11d. Light entering the sample interface is depicted as refracting at the surface of the sample interface. A reflective element 1166 mounts with the frame and sample interface such that light reflects therefrom and enters the sample interface from two directions. After refraction at the sample interface surface, the light entering from one direction illuminates a first portion of the sample interface surface 1163, while that entering from the other direction illuminates a second portion of the sample interface surface 1163. Depending on the needs of the application, the exit portion of the sample interface can be according to any of the various examples described here.

Example Application

FIG. 12 is a schematic representation of an example apparatus suitable for some applications of the present invention. A light source 9 supplies light to a collimating mirror 7. The resulting collimated light beam travels to a beamsplitter 10, which is the beamsplitter of a Michelson interferometer. The beam is split into two beams which travel to two end mirrors of the interferometer 12a, 12b. Mirror 12a is the fixed mirror and mirror 12b is the moving mirror of the interferometer. The beams then return to beamsplitter 10 where they recombine and exit towards mirror 11. Mirror 11 focuses the beam onto aperture 17, the size of which is adjustable. The beam then travels to focusing mirror 15 which re-images aperture 17 onto the sample holder 23. The sample holder 23 can be mounted in an orientation that allows the beam to be incident on an edge of the sample holder as described previously. The beam passes through the edge and is totally internally reflected within the sample holder 23. After the beam passes through the sample holder 23 and exits the opposing edge, it continues to mirror 28. Mirror 28 refocuses the beam onto a detector 29 or array of detectors. The imaging of the sample holder 23 onto a detector 29 or array of detectors can define different regions of the sample-holding surface as a consequence of the direction and divergence of the beam relative to the sample holder and of the beam being totally internally reflected within the sample holder 23. Plan view 30 is a representation of the sampling-holding surface of sample holder 23, whereby it is conceptually separated into different regions or portions 31. The signal at the detector can be processed by a computer 50, and the resultant spectrum can be stored on the hard disk and displayed on the monitor 51. A spectrum can be stored for each of the regions 31 on the sample holder to be mapped.

Example Application—Measurement of Cytology Samples

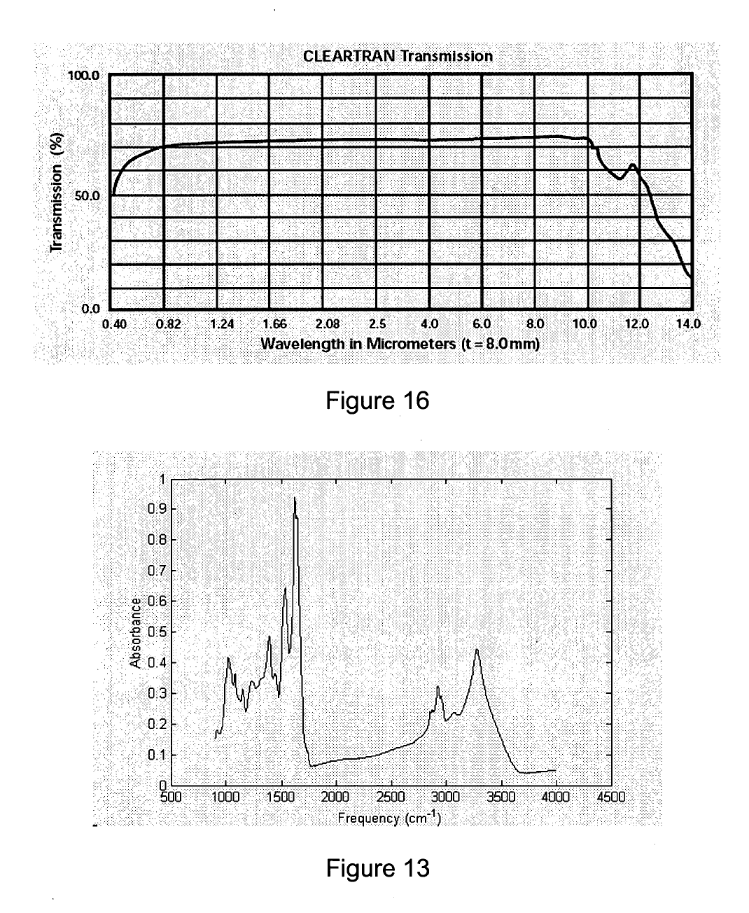

Currently, cervical cytology samples are screened and diagnosed by using the human eye to detect subtle morphological differences in cells. However, infrared spectroscopy is sensitive to the rotational and vibrational energy levels of bonds, functional groups and molecules. The spectra thus contain information about the biochemical and morphological make-up of cells or tissue samples. This information can be used to classify cells or tissues into classes according to some descriptive difference, such as cell type or disease status. With this said, there is still a desire to not disrupt the current screening process of allowing the pathologist to make the diagnosis of the abnormal pap samples. Therefore having a measurement that classifies slides as either “Normal” or “In Need of Further Review” is desirable. This however puts a restriction on the type of slide that can be used for this process; the slide must be made out of a material that is transmissive to the mid-infrared instrumentation, as well as to the pathologist looking at the slide underneath a microscope. A sample holder according to the present invention can accommodate this requirement. FIG. 13 is a mid-infrared spectrum of dried cervical cells plated onto a CLEARTRAN sample holder (using a sample preparation technology marketed by Cytyc under the trademark THINPREP) similar to the sample holder illustrated in FIG. 6. The geometry of the CLEARTRAN crystal was chosen to allow for the measurement of the dried cervical cells in a manner that optimizes the number of ATR reflections to maximize the absorbance signal.

Once the data has been collected, then sophisticated multivariate techniques, such as principle component analysis, can combine the spectral values at many different wavelengths of light to provide classification ability. A classification model such as linear discriminant analysis is generated (trained) from a set of spectral data with classes known from an accurate, “gold standard” reference method. The goal of model generation is to seek some relationship (defined by the type of algorithm being used) between the spectral data and the known classes. This model can then be used to predict the classes of new samples measured.

Example Application—Measurement in Dried Biological Fluid

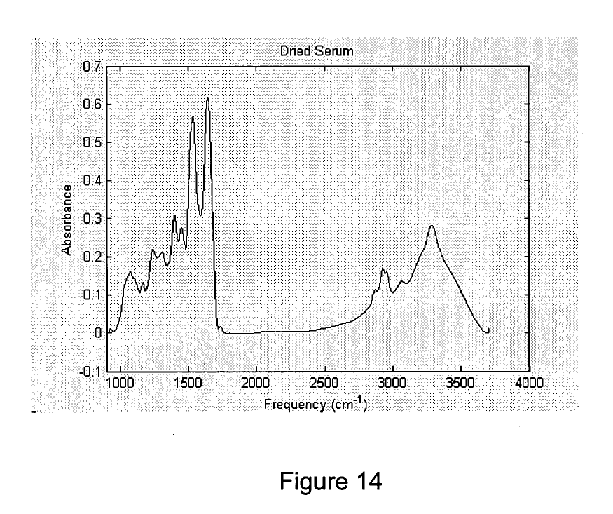

The measurement of analytes in human serum currently consists of measuring each analyte individually, as well as using expensive reagents for this type of measurement (i.e., J&J OCD's Vitro Analyzers). However, infrared spectroscopy is sensitive to the rotational and vibrational energy levels of bonds, functional groups and molecules. The spectra thus contain information about the quantitative chemical make-up of the serum samples. This information can be used to simultaneously quantify the concentration of several analytes in a single serum sample without the use of many expensive reagents. This information can also be used to classify serum samples based upon the analyte makeup of the serum samples. Measuring a dried serum sample by transmission is less than ideal for a spectroscopic measurement, due to the non-uniform drying of the serum sample (i.e., dries leaving a higher concentration of material at the perimeters of the sample). This creates accuracy problems for a transmission measurement due to the non-uniformities in pathlength, as well as spectral artifacts due to the scattering of the light from the front surface of the sample. However, if the sample is dried onto a sample holder according to the present invention, the light interaction will not encounter the nonuniformity of the sample because of the encompassing penetration depth of the evanescent wave, thereby generating a more ideal spectrum to improve the accuracy of the mid-infrared measurement. FIG. 14 is a mid-infrared spectrum of human serum dried onto a sample holder similar in geometry to that in FIG. 5.

Example Application—Measurement of Non-Biological Materials

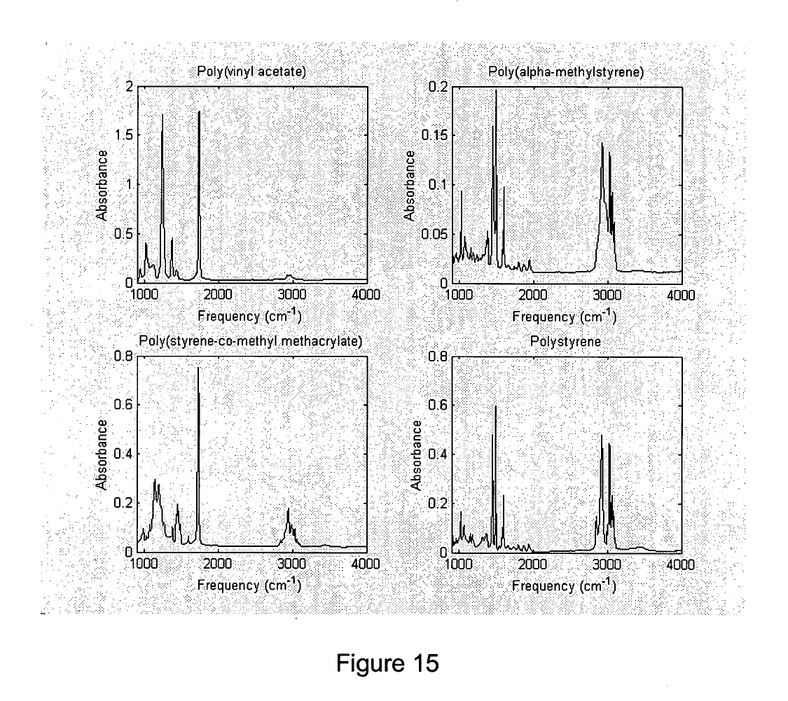

A sample holder according to the present invention can also be used to measure non-biological samples, for example coatings or films placed onto the sample holder. The spectra obtained from the measurement of these films or coatings contain information about the quantitative chemical make-up of these films or coatings. This information can be used to quantify the concentration of individual components within this film or coating, as well as it can be used to classify the film or coating samples based upon the component makeup of the samples. As an example of the this application, four polymers (Polystyrene, Poly(alpha-methylstyrene), Poly(styrene-co-methyl methacrylate), Poly(vinyl actete) were dissolved in Toluene and coated onto sample holders similar in geometry to that in FIG. 6. FIG. 15 shows the spectra of these four polymers.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

We claim:

1. A sample holder comprising a body, of a material that is functionally transparent to at least some wavelengths of visible light, and functionally transparent to at least some wavelengths of infrared light, and that defines:
a. A first face, defining a region adapted to support a sample, where the first face is substantially planar in the region;
b. A second face, substantially parallel to the first face.

2. A sample holder as in claim 1, wherein the material is functionally transparent to near-infrared light.

3. A sample holder as in claim 1, wherein the material is functionally transparent to mid-infrared light.

4. A sample holder as in claim 1, wherein the region is adapted to support a biological sample.

5. A sample holder as in claim 1, wherein the region is adapted to support a non-biological sample.

6. A sample holder as in claim 1, wherein the shape of the body is compatible with contemporary infrared microscopes.

7. A sample holder as in claim 1, wherein the shape of the body is compatible with contemporary focal plane array systems.

8. A sample holder as in claim 1, wherein the shape of the body is compatible with contemporary optical microscopes.

9. A sample holder as in claim 1, wherein the dimensions of the body are compatible with contemporary optical microscopes.

10. A sample holder as in claim 1, where the body has a length of from 0.25 to 4 inches, a width of from 0.1 to 1.5 inches, and a thickness of from 0.01 to 0.1 inches.

11. A sample holder as in claim 10, wherein the body has a length of about 3 inches, a width of about 1 inch, and a thickness of about 0.04 inch.

12. A sample holder as in claim 10, wherein the body has a length of 0.25 inches to 2.5 inch, a width of 0.1 inches to 1 inch, and a thickness of 0.01 to 0.1 inches.

13. A sample holder as in claim 1, wherein the sample holder index of refraction is amenable to attenuated total internal reflection of infrared light.

14. A sample holder as in claim 1, wherein the sample holder index of refraction is from 1.3 to 3.5.

15. A sample holder as in claim 1, wherein the material comprises: Barium Fluoride, Caesium Iodide, Calcium Fluoride, Cubic Zirconium, Diamond, Lithium Fluoride, Magnesium Fluoride, Potassium Bromide, Potassium Chloride, Quartz, Sapphire, Silver Bromide, Silver Chloride, Sodium Chloride, Thallium Bromide, Thallium Bromo-lodide, Thallium Bromo-Chloride, Zinc Selenide, Zinc Sulfide, Multispectral Zinc Sulfide.

16. A sample holder as in claim 1, wherein the material separating the first and second faces defines first and second opposing edges, where the first and second opposing edges intersect the first face along substantially parallel lines, and wherein the first and second edges are oriented at first and second angles, respectively, to the first face.

17. A sample holder as in claim 16, wherein the first and second angles are about 90 degrees.

18. A sample holder as in claim 16, wherein the first and second angles are substantially equal.

19. A sample holder as in claim 16, wherein the second edge intersects the second surface at an angle substantially the same as the first angle.

20. A sample holder as in claim 16, wherein the first angle is in the range from 10 to 90 degrees.

21. A sample holder as in claim 16, wherein the first angle is about 50 degrees.

22. A sample holder as in claim 16, wherein the first and second edges are finished to an optically smooth surface.

23. A sample holder as in claim 16, wherein the first and second edges are treated with at least one of:
a. an antireflective coating;
b. a reflective coating;
c. a selective spectral transmission coating.

24. A sample holder comprising:
a. a frame,
b. a sample interface mounted with the frame, where the sample interface comprises:
i. a material that is functionally transparent to at least some wavelengths of visible light and functionally transparent to at least some wavelengths of infrared light, and that defines
ii. a first face, defining a region adapted to support a sample, where the first face is substantially planar in the region;
iii. a second face, substantially parallel to the first face.

25. A sample holder as in claim 24, wherein the shape of the frame is compatible with contemporary optical microscopes.

26. A sample holder as in claim 24, wherein the dimensions of the frame are compatible with contemporary optical microscopes.

27. A sample holder as in claim 24, where the frame has a length of from 1 to 4 inches, a width of from 0.5 to 1.5 inches, and a thickness of from 0.01 to 0.1 inches.

28. A sample holder as in claim 27, wherein the frame has a length of about 3 inches, a width of about 1 inch, and a thickness of about 0.04 inch.

29. A sample holder as in claim 24, wherein the sample interface index of refraction is amenable to attenuated total internal reflection of light in the mid-infrared region.

30. A sample holder as in claim 24, wherein the material comprises: Barium Fluoride, Caesium Iodide, Calcium Fluoride, Cubic Zirconium, Diamond, Lithium Fluoride, Magnesium Fluoride, Potassium Bromide, Potassium Chloride, Quartz, Sapphire, Silver Bromide, Silver Chloride, Sodium Chloride, Thallium Bromide, Thallium Bromo-lodide, Thallium Bromo-Chloride, Zinc Selenide, Zinc Sulfide, Multispectral Zinc Sulfide.

31. A sample holder as in claim 24, wherein the material separating the first and second faces defines first and second opposing edges, where the first and second opposing edges intersect the first surface along substantially parallel lines, and wherein the first and second edges are oriented at first and second angles, respectively, to the first surface.

32. A sample holder as in claim 31, wherein the first and second angles are about 90 degrees.

33. A sample holder as in claim 32, wherein the first and second angles are substantially equal.

34. A sample holder as in claim 31, wherein the second edge intersects the second surface at an angle substantially the same as the first angle.

35. A sample holder as in claim 31, wherein the first angle is in the range from 10 to 90 degrees.

36. A sample holder as in claim 31, wherein the frame defines an opening, wherein the opening is adapted to mount with the sample interface leaving space between the frame and the sample interface adjacent the first and second edges.

37. A sample holder as in claim 36, wherein the space accommodates substantially unobstructed passage of light to the sample interface.

38. A sample holder as in claim 36, wherein the sample interface mounts with the frame using ledges on the frame, clips mounted with the frame and engaging the sample interface, clips mounted with the sample interface and engaging the frame, an interference fit of the fame and the sample holder, an adhesive in contact with the sample holder and the frame, or a combination thereof.

39. A sample holder for cancer analysis, comprising a body of a material that is functionally transparent to at least some wavelengths of visible light, and functionally transparent to at least some wavelengths of infrared light, where the body defines:
a. A first face, defining a region adapted to support a sample comprising biological material, where the first face is substantially planar in the region;
b. A second face, substantially parallel to the first face.

40. A cervical cancer screening apparatus, comprising:
a. A sample holder, comprising a body of a material that is functionally transparent to at least some wavelengths of visible light, and functionally transparent to at least some wavelengths of infrared light, the body defining:
i. A first face, defining a region adapted to support a sample comprising cervical cells, where the first face is substantially planar in the region;
ii. A second face, substantially parallel to the first face.
b. Means for directing light to the sample holder;
c. Means for collecting light after interaction with a sample supported by the sample holder;
d. Means for analyzing the collected light to determine a characteristic of the sample related to cervical cancer.
